(19) United States
(12) Patent Application Publication
(10) Pub. No.: US 2024/0082821 A1
(43) Pub. Date: Mar. 14, 2024

(54) NON-POROUS HYBRID COATED POLYMER PARTICLES

(71) Applicant: Waters Technologies Corporation, Milford, MA (US)

(72) Inventors: Mingcheng Xu, Lexington, MA (US); Darryl W. Brousmiche, Grafton, MA (US); Daniel P. Walsh, Danvers, MA (US); Nicole L. Lawrence, Stafford Springs, CT (US); Kevin D. Wyndham, Upton, MA (US)

(73) Assignee: Waters Technologies Corporation, Milford, MA (US)

(21) Appl. No.: 18/174,217

(22) Filed: Feb. 24, 2023

Related U.S. Application Data
(60) Provisional application No. 63/401,497, filed on Aug. 26, 2022.

(51) Int. Cl. B01J 20/289; B01J 20/10; B01J 20/26; B01J 20/28; B01J 20/32

(52) U.S. Cl. CPC B01J 20/289; B01J 20/103; B01J 20/261; B01J 20/28071; B01J 20/321; B01J 20/3219; B01J 20/3234; B01J 20/3293; B01J 2220/46

(57) ABSTRACT

The present disclosure pertains to non-porous composite particles that are non-porous, polymer-based, organic-inorganic materials. In various embodiments, a non-porous polymer core is surface modified. In various embodiments, a non-porous hybrid organic-inorganic material is disposed on the modified surface of the core. The present disclosure pertains to chromatographic separation devices that comprise such non-porous composite particles.

### CROSS-REFERENCE TO RELATED APPLICATIONS

This application claims priority to and the benefit of U.S. Provisional Application Ser. No. 63/401,497, filed Aug. 26, 2022, and entitled “Non-Porous Hybrid Coated Polymer Particles.” The foregoing application is incorporated herein by reference in its entirety.

### FIELD OF TECHNOLOGY

The present technology is directed to chromatographic materials. More particularly, the present technology is directed to non-porous composite particles for use in chromatographic separations. In general, the non-porous composite particles comprise a non-porous polymer core and a non-porous hybrid organic-inorganic material disposed about the core.

### BACKGROUND

Chromatography is a separation process involving two phases, one stationary and the other mobile. Typically, the stationary phase is a porous or non-porous particle that is packed into a column. The mobile phase flows through the packed column. The sample, or analytes, to be separated is injected at the beginning of the column and is transported through the system by the mobile phase. In their travel through the column, the different components of the sample distribute themselves according to their relative affinity for the two phases. The results of the chromatographic separation is then depicted via a chromatogram, where the sample components can be identified by various peaks or patterns of the chromatogram.

Measuring the degree of separation between two components is commonly referred to as the resolution of each component. The resolution can be determined by efficiency, selectivity, and retention of the separation process. Efficiency refers to the quality of separation of the sample components, which is typically determined by the number of peaks that can be separated in the chromatogram. Selectivity refers to the ability of the chromatographic method to separate the components of the sample and is typically measured by a ratio of the retention of two peaks in question of the chromatogram and can be visualized as the distance between the apices of the two peaks. Retention, or retention time, refers to the time required for the sample to pass through the chromatographic column, and is typically measured as the interval of time between the injection of the sample and the detection of its components on the chromatogram.

Adjustment of mobile phase pH is a powerful tool to improve retention and selectivity in chromatographic separation of analytes, especially of ionizable analytes. A high pH mobile phase combined with elevated temperature is typically used to gain extended retention, excellent peak shape and good efficiency in reversed phase chromatographic separation of basic compounds, peptides, and biological samples. Silica-based stationary phases have been preferred in the past, due to its stability at neutral pH and high temperature. However, a common drawback is the instability of silica-based stationary phases at high pH due to particle erosion caused by dissolution, which in turn limits its use in those applications. An alternative to silica based stationary phases is to use a polymer-based stationary material. Polymer-based stationary particles have showed some promise, but also have some limitations in choice of the desired surface chemistries.

Mass transfer and lateral diffusion properties are paramount in the high-resolution separation of large biomolecules, such as those with a hydrodynamic radius that exceeds 300 Å, with some even exceeding 1000 Å. However, in the separation of large biomolecules, the diffusion paths that analytes must traverse between the non-porous stationary phase and mobile phase is very short, and column efficiency becomes independent of the flow rate. Accordingly, non-porous particles with a hybrid composition for use in a stationary phase that have the ability to remain stable at high pH and obtain a high-resolution of separation of large biomolecules is desirous.

### SUMMARY OF TECHNOLOGY

The present technology is directed to non-porous composite particles for use in chromatographic separations. In particular, the embodiments of the present technology relate to chromatographic separations of large biomolecules.

The technology disclosed herein comprises a surface-modified non-porous polymer core and a non-porous hybrid organic-inorganic material disposed about the surface-modified non-porous polymer core. That is, embodiments of the present disclosure are directed to a non-porous composite particle including a non-porous polymer particle core having a modified surface and a non-porous hybrid organic-inorganic layer in contact with the modified surface. In some embodiments, the modified surface is a silyl-modified surface comprising a first functionality and a second functionality. In certain embodiments, the modified surface is covalently and/or electrostatically bonded to the non-porous hybrid organic-inorganic material. As a result of using such non-porous particles in a stationary phase of a chromatographic separation, the non-porous particles are able to remain stable at high pH and obtain a high-resolution of separation of large biomolecules.

In one aspect, the present technology is directed to a non-porous composite particle comprising a non-porous polymer particle core having a silyl modified surface, and a non-porous hybrid organic-inorganic layer in contact with the silyl modified surface.

The above aspect can include one or more of the following features. The non-porous polymer particle core of the non-porous composite particles, in some embodiments, is a product of at least one monomer. In some embodiments, the at least one monomer is a radical polymerizable monomer. In some embodiments, the at least one monomer comprises at least two functional groups. In some embodiments, the at least one monomer is capable of polymerizing by ring opening polymerization or condensation polymerization.

Some embodiments can include one or more of the following features (in combination with any of the above features). In some embodiments, the non-porous polymer core is divinylbenzene (80%). In some embodiments, the silyl modified surface of the non-porous polymer particle core includes a first functionality and a second functionality, the first functionality comprising a reactive silane and the second functionality comprising an organic polymerizable group. In some embodiments, the reactive silane comprises an alkoxy. In some embodiments, the organic polymerizable group comprises vinyl. In some embodiments, the silyl modified surface of the non-porous polymer particle being modified with at least one of N-Vinylpyrrolidone, N-Vinylcaprolactam, N,N-Dimethylvinylbenzylamine, Methacryloxypropyltrimethoxylsilane, or p-Styryltrimethoxysilane. In some embodiments, the silyl modified surface of the non-porous polymer particle core comprises at least one functional group that covalently bonds with an organometallic compound. In some embodiments, the silyl modified surface of the non-porous polymer particle core comprises at least one functional group that electrostatically interacts with the non-porous hybrid organic-inorganic layer.

Additional features of the above aspect may include one or more of the following. In some embodiments, the non-porous hybrid organic-inorganic layer of the non-porous composite particle has a thickness range within the range of 1 nm to 4 microns, more preferably from 25 nm to 200 nm. In some embodiments, the non-porous hybrid organic-inorganic layer has a pore volume less than 0.10 cc/g. In some embodiments, the non-porous hybrid organic-inorganic layer comprises a material selected from the group consisting of: silica, alumina, titanium, cerium, zirconium, silica oxide, alumina oxide, cerium oxide, zirconium oxide, ceramic material, and combinations thereof. In some embodiments, the non-porous hybrid organic-inorganic layer comprises a silicon-based material. In some embodiments, the silicon-based material comprises silicon atoms having one or more silicon-oxygen bonds and one or more silicon-carbon bonds. In some embodiments, the non-porous hybrid organic-inorganic layer comprises a substituted or unsubstituted alkylene, alkenylene, alkynylene or arylene moiety bridging two or more silicon atoms.

The present technology provides a number of advantages over current means of chromatographic separation. For instance, using a non-porous composite particle described herein can provide a high-resolution of separation of large biomolecules. That is, a non-porous polymer particle core having a silyl-modified surface and a non-porous hybrid organic-inorganic layer in contact with the silyl-modified surface can provide better separation of large biomolecules than the current means used in the industry. The present technology can remain stable at high pH. As a result, chromatographic separations using the non-porous composite particle described herein can lead to extended retention, better peak shape, and more high efficiency in large analytes separation of large biomolecules.

### BRIEF DESCRIPTION OF THE DRAWINGS

The foregoing and other features and advantages provided by the present technology will be fully understood from the following description of exemplary embodiments when read together with the accompanying drawings.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a cross-sectional schematic illustration of a non-porous composite particle, in accordance with an embodiment of the present disclosure.

FIG. 2 illustrates volume versus particle diameter, in accordance with example 2 of the present disclosure.

FIG. 3 is a scanning electron microscope photograph of particle cross-sections of the whole particles formed in accordance with sample 2C of the present disclosure.

FIG. 4 is a scanning electron microscope photograph of whole particles formed in accordance with sample 4G.

FIG. 5 is a scanning electron microscope photograph of particle cross-sections of the whole particles formed in accordance with sample 4G.

FIG. 6 is a scanning electron microscope photograph of whole particles formed in accordance with sample 4H.

FIG. 7 is a scanning electron microscope photograph of particle cross-sections of the whole particles formed in accordance with sample 4H.

FIG. 8 is a scanning electron microscope photograph of whole particles formed in accordance with sample 41.

FIG. 9 is a scanning electron microscope photograph of particle cross-sections of the whole particles formed in accordance with sample 41.

FIG. 10 is a scanning electron microscope photograph of whole particles made in accordance with example 3 of the present disclosure.

FIG. 11 is a magnified scanning electron microscope photograph of a whole particle made in accordance with example 3 of the present disclosure.

FIG. 12 is a scanning electron microscope photograph of whole particles formed in accordance with sample 4G of the present disclosure and then primed with poly(N-vinyl pyrrolidone).

FIG. 13 is a magnified scanning electron microscope photograph of a whole particle formed in accordance with sample 4H of the present disclosure and then primed with poly(N-vinyl pyrrolidone).

FIG. 14 is a scanning electron microscope photograph of particle cross-sections of the whole particles formed in accordance with sample 6D.

FIG. 15 is a scanning electron microscope photograph of particle cross-sections of the whole particles formed in accordance with sample 6H.

### DETAILED DESCRIPTION

The present disclosure pertains to non-porous composite particles that comprise a non-porous polymer particle core with a silyl-modified surface, and a non-porous hybrid organic-inorganic material in contact with the silyl-modified surface. That is, embodiments of the present disclosure are directed to a non-porous composite particle including a non-porous polymer (e.g., organic material) particle core having a modified surface and a hybrid organic-inorganic non-porous material (e.g., layer) in contact with the modified surface. In some embodiments, the modified surface is a silyl-modified surface comprising a first functionality (i.e., a reactive silane) and a second functionality (i.e., an organic polymerizable group). In certain embodiments, the modified surface is covalently and/or electrostatically bonded to the hybrid organic-inorganic non-porous material.

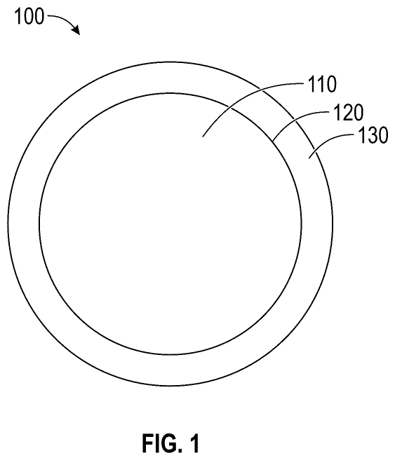

As shown in FIG. 1, a non-porous composite particle 100 according to an embodiment of the present disclosure is provided. The non-porous composite particle 100 has a non-porous polymer particle core 110 and a hybrid organic-inorganic non-porous material 130 surrounding the core 110. In this embodiment, the non-porous polymer particle core 110 has a modified surface 120 and the hybrid organic-inorganic non-porous material 130 is disposed on the modified surface 120.

The non-porous composite particles of the present disclosure are typically spherical. The non-porous composite particles of the present disclosure typically range from 1 to 14 microns in diameter, more typically, from 1 to 6 microns in diameter. Particle diameter is measured herein by Coulter Counter ((Beckman Coulter, Multisizer 4e Coulter Counter, Brea, CA, USA) by dispersing a sample in methanol containing 5% lithium chloride. A greater than 70,000 particle count is run using a 30 μm aperture in the volume mode for each sample. Using the Coulter principle, volumes of particles are converted to diameter, where a particle diameter is the equivalent spherical diameter, which is the diameter of a sphere whose volume is identical to that of the particle. Particle diameter measured as the 50% cumulative diameter of the volume based particle size distribution.

The non-porous composite particles of the present disclosure have good stability, even at pH's greater than 12 and less than 1, in some embodiments. For example, in an embodiment, non-porous composite particles in accordance with present technology exhibited less than 4% weight loss after a 12 hour exposure to an aqueous solution having a pH of 12.3. Columns packed with these non-porous composite particles and exposed to basic conditions showed minimum loss in separation performance. As a result, the non-porous composite particles of the present disclosure, which have a non-porous polymer core and a non-porous hybrid inorganic-organic material are tailored to provide exceptional separation of large biomolecules.

The non-porous composite particles of the present disclosure are also typically narrowly dispersed in particle size. As defined herein, a collection of particles is “narrowly dispersed in particle size” when a ratio of 90% cumulative volume diameter divided by the 10% cumulative volume diameter is less than 1.4 when measured by Beckman Coulter, Multisizer 4e Coulter Counter.

### Non-Porous Polymer Core.

Referring to FIG. 1, the core 110 of the non-porous composite particle 100 is polymeric and non-porous. The polymer particle cores for use in the present disclosure comprise at least one organic polymer. The organic polymer cores typically contain more than 95% organic polymer, more typically more than 97.5% organic polymer, even more typically more than 99% organic polymer.

The polymer particle cores are non-porous, which is defined herein to mean that the polymer particle cores have a pore volume that is less than 0.1 cc/g. Preferably, organic polymer cores have a pore volume that is less than 0.10 cc/g (e.g., 0.05 cc/g), and preferably less than 0.02 cc/g, in some embodiments. Pore volume is determined using methods known in the art based on multipoint nitrogen sorption experiments (Micromeritics ASAP 2400; Micromeritics Instruments Inc., Norcross, GA).

The polymer cores typically range, for example, from 1 to 10 microns in diameter, more typically, from 1 to 5 microns in diameter. The polymer cores are typically narrowly distributed in particle size.

Elementally, polymer particle cores for use in the present disclosure include those that are composed of carbon and hydrogen, those composed of carbon, hydrogen and oxygen, those composed of carbon, hydrogen and nitrogen, and those composed of carbon, hydrogen, nitrogen and oxygen. The backbones of the organic polymer chains forming the polymer cores may contain C—C, C—O, C—N and/or O—N covalent bonds. In some embodiments (e.g., in the case of a polymer formed by radical polymerization of vinyl groups), the backbone of the at least one organic polymer chains may contain only C—C covalent bonds.

As noted above polymer cores for use in the present disclosure comprise at least one organic polymer. The at least one organic polymer comprises residues of one or more organic monomers. The one or more organic monomers residues forming the least one organic polymer may be selected from residues of hydrophobic organic monomers, residues of hydrophilic organic monomers, or a mixture of residues of hydrophobic organic monomers and residues of hydrophilic organic monomers.

Hydrophobic organic monomers may be selected, for example, from a C2-C18 olefin monomer and/or a monomer comprising a C6-C18 monocyclic or multicyclic carbocyclic group (e.g., a phenyl group, a phenylene group, naphthalene group, etc.). Specific examples of hydrophobic organic monomers include, for example, monofunctional and multifunctional aromatic monomers such as styrene, alkyl substituted styrene, halo substituted styrene, divinylbenzene, and vinylbenzyl chloride, monofunctional and multifunctional olefin monomers such as ethylene, propylene or butylene, monofunctional and multifunctional fluorinated monomers such as fluoroethylene, 1,1-(difluoroethylene), tetrafluoroethylene, chlorotrifluoroethylene, hexafluoropropylene, perfluoropropylvinylether, or perfluoromethylvinylether, monofunctional or multifunctional acrylate monomers having a higher alkyl or carbocyclic groups, for example, monofunctional or multifunctional acrylate monomers having a C6-C18 alkyl, alkenyl or alkynyl group or a C6-C18 saturated, unsaturated or aromatic carbocyclic group, monofunctional or multifunctional methacrylate monomers having a higher alkyl or carbocyclic group, for example, monofunctional or multifunctional methacrylate monomers having a C6-C18 alkyl, alkenyl or alkynyl group or a C6-C18 saturated, unsaturated or aromatic carbocyclic group, among others.

Hydrophilic organic monomers may be selected, for example, from monofunctional or multifunctional organic monomers having an amide group, monofunctional or multifunctional organic monomers having an ester group, monofunctional or multifunctional organic monomers having a carbonate group, monofunctional or multifunctional organic monomers having a carbamate group, monofunctional or multifunctional organic monomers having a urea group, monofunctional or multifunctional organic monomers having a hydroxyl group, and monofunctional or multifunctional organic monomers having a nitrogen-containing heterocyclic group, among other possibilities. Specific examples of hydrophilic organic monomers include, for example, vinyl pyridine, N-vinylpyrrolidone, N-vinyl-piperidone, N-vinyl caprolactam, lower alkyl acrylates (e.g., methyl acrylate, ethyl acrylate, etc.), lower alkyl methacrylates (e.g., methyl methacrylate, ethyl methacrylate, etc.), vinyl acetate, acrylamide or methacrylamide monomers, hydroxypolyethoxy allyl ether monomers, ethoxy ethyl methacrylate, glycidyl methacrylate, ethylene glycol dimethacrylate, methylene bisacrylamide, allyl methacrylate, or diallyl maleate.

In various embodiments, the non-porous polymer cores comprise residues of multifunctional hydrophobic organic monomers such as divinylbenzene and/or multifunctional hydrophilic organic monomers, such as ethylene glycol dimethacrylate, methylene bisacrylamide or allyl methacrylate, in order to provide crosslinks in the organic copolymer. In certain embodiments, DVB 80 may be employed, which is an organic monomer mixture that comprises divinylbenzene (80%) as well as a mixture of ethyl-styrene isomers, diethylbenzene, and can include other isomers as well.

In various embodiments, the polymer core may comprise residues of only multifunctional organic monomers. In various embodiments, the polymer may comprise residues of both multifunctional organic monomers and monofunctional organic monomers.

The present inventors have found that, in some embodiments, the porosity of a material formed from an polymer containing multifunctional organic monomer residues can be reduced by adding monofunctional organic monomer residues to the polymer, or that the porosity of a material formed from a polymer containing multifunctional organic monomer residues and monofunctional organic monomer residues can be reduced by increasing an amount of the monofunctional organic monomer residues relative to the multifunctional organic monomer residues in the polymer. For example, it has been found that polymer particle cores formed from DVB 80 (which are formed from organic polymers containing 80% multifunctional divinyl benzene monomer residues and monofunctional ethylstyrene monomer residues as explained above) have a porosity of about 0.015 cc/g, whereas organic polymer cores formed from DVB 80 and styrene (which contain multifunctional divinyl benzene monomer residues, monofunctional ethylstyrene monomer residues, and additional monofunctional styrene monomer residues) have a porosity of less than 0.007 cc/g.

In some embodiments, polymer particle cores are created in which a central region of the cores is formed from an organic copolymer containing multifunctional organic monomer residues and monofunctional organic monomer residues and an outer region of the cores is formed from an organic homopolymer containing only multifunctional organic monomer residues. In some embodiments, organic polymer cores are created in which a central region of the cores is formed from an organic copolymer containing multifunctional organic monomer residues and monofunctional organic monomer residues and an outer region of the cores is also formed from an organic copolymer containing multifunctional organic monomer residues and monofunctional organic monomer residues, but wherein a molar ratio of the multifunctional organic monomer residues relative to the monofunctional organic monomer residues is increased in the outer core region relative to the central core region. In a particular example, organic polymer cores are created in which a central region of the cores is formed from DVB and styrene and an outer region of the cores is formed from DVB. In other embodiment, the molar ratio of the multifunctional organic monomer residues relative to the monofunctional organic monomer residues is decreased in the outer core region relative to the central core region.

In various embodiments, an entire polymer particle core may be formed from an organic polymer that comprises residues of multifunctional organic monomers but does not contain resides of monofunctional organic monomers. In various embodiments, an entire polymer particle core may be formed from an organic polymer that comprises residues of both multifunctional organic monomers and monofunctional organic monomers.

The polymers forming the polymer particle cores can be prepared via a number of processes and mechanisms including, but not limited to, chain addition and step condensation processes, radical, anionic, cationic, ring-opening, group transfer, metathesis, and photochemical mechanisms. In particularly beneficial embodiments, the non-porous polymer particle cores are prepared via free radical polymerization.

The polymer particle cores of the present disclosure can be prepared in some embodiments by a dispersion polymerization process in which a homogeneous solution is formed, wherein monomers, initiator and stabilizer are combined in a solvent or solvent mixture. As polymerization proceeds, the initially formed polymers precipitate from the homogeneous solution to form nuclei. The nuclei that form still bear reactive sites such as radicals which allow them to keep growing by continuous capture and incorporation of monomers and/or oligomers from the solution.

In an exemplary process based on radical polymerization, one or more solvents and one or more stabilizers are purged with nitrogen to remove dissolved oxygen. Then, one or more monomers, including at least one multifunctional monomer, and a radical polymerization initiator are added. Radical polymerization is initiated by raising the temperature for several hours, typically under agitation. Based on the desired particle diameter, further radical polymerization initiator and further monomer may be added to the reaction mixture to allow the particle further to grow to the desired size. After reaction, the particles may be thoroughly washed and dried under vacuum.

Any radical initiator that is compatible with the organic phase may be used, either alone or in a mixture of such radical initiators. In particular embodiments, the radical initiators are capable of being heat activated or photoactivated. In specific embodiments, the radical initiator is a peroxide, a peroxyacetate, a persulfate, an azo initiator or a mixture thereof.

Where the initiator is a thermal initiator, the resulting solution may then be heated to an elevated temperature under agitation to activate the thermal initiator(s) and maintained at elevated temperature until polymerization is complete. Where the initiator is a photoinitiator, the resulting solution may then be illuminated under agitation with light having a suitable wavelength to activate the photoinitiator(s) and maintained until polymerization is complete. Suitable organic monomers for use in the organic phase are described above.

Solvent systems for the formation of polymer particle cores include methanol, ethanol, isopropanol, 2-methoxyehanol, water, acetonitrile, p-xylene, and toluene.

Stabilizers that can be employed for the formation of polymer particle cores include, for example, polyvinylpyrrolidone (PVP), non-ionic surfactants including alkylphenol ethoxylates (e.g., Triton™ N-57, available from Dow Chemical), polyvinyl alcohol (PVA) such as Selvol™ Polyvinyl Alcohol solution, available from Sekisui Special Chemicals), modified celluloses, including alkyl-modified celluloses such as methyl celluloses (e.g., Methocel™, available from DuPont) and hydrophobically modified celluloses hydroxyethylcellulose stabilizers such as Natrosol™ cetyl modified hydroxyethylcellulose (available from Ashland), and ionic surfactants including sodium alkyl sulfates such as sodium dodecyl sulfate (SDS) and sodium oleyl sulfate, among others.

In a particular embodiment of non-porous polymer particle core formation, the monomer is a combination of DVB and styrene, the initiator is 2,2′-Azobis(2-methylpropionitrile) (AIBN), the solvent system is a combination of reagent alcohol and p-xylene, and the stabilizer is polyvinyl pyrrolidone (PVP 40).

Once formed, the organic polymer cores may contain surface moieties from which further polymerization can proceed. For example, non-porous polymer particle cores formed from free radical polymerization commonly contain residual radical-polymerizable unsaturated surface moieties (e.g., ethylenyl moieties, vinyl moieties, methacryloxy moieties, or acryloxy moieties, etc.), from which further core growth can proceed. Such further polymerization may be used to increase the size of a given batch of polymer particle cores by adding an additional thickness of non-porous organic polymer to previously formed non-porous polymer particle cores.

In a particular embodiment of non-porous polymer particle core growth, the monomer is DVB, the solvent is reagent alcohol, and the stabilizer is polyvinyl pyrrolidone (PVP 40). Surface-modified non-porous polymer core.

In some embodiments, the application is directed to a non-porous polymer particle with a modified surface. That is, the non-porous polymer core 110 includes modified surface 120 on the core's exterior. See FIG. 1. The modified surface of the non-porous polymer particle, in some embodiments, can form a covalent or electrostatic bond with a subsequently applied non-porous hybrid organic-inorganic material 130. In certain embodiments, the modified surface of the non-porous polymer core is a silyl modified surface. The silyl modified surface can include a first functionality and a second functionality. For example, the first functionality is a reactive silane (e.g., alkoxy) and the second functionality is an organic polymerizable group (e.g., vinyl). The modified surface 120 is useful for connecting or adhering the hybrid organic-inorganic non-porous material 130 to the core 110.

In some embodiments, the modified surface of the non-porous polymer particle core can have a thickness ranging from 1 to 300 nm, for example ranging anywhere from 1 to 3 to 10 to 30 to 100 to 300 nm (i.e., ranging between any two of the preceding values). In an embodiment, the modified surface has a thickness or is defined by a region having an approximate thickness of between 10 nm and 30 nm. That is, the thickness of the modified surface may extend solely from the exterior surface of the core; or in some embodiments, the thickness of the modified surface may extend into the core as an exterior portion of the core may be modified to define all of or a portion of the thickness of the modified surface.

In some embodiments, the modified surface includes a surface polymer, which may comprise functional groups that covalently or electrostatically bond to the hybrid organic-inorganic non-porous material (e.g., material 130 of FIG. 1). Examples of functional groups that electrostatically bond to the hybrid organic-inorganic non-porous material include amide functional groups and amine functional groups. In this regard, the hybrid organic-inorganic materials described herein are weakly acidic in nature and thus tend to be deprotonated and negatively charged, whereas the amide functional groups or amine functional groups described herein are basic in nature and thus tend to be protonated and positively charged. Examples of functional groups that covalently bond to the hybrid organic-inorganic non-porous material include organosilane functional groups, and organometallic functional groups such as organotitanium functional groups and organozirconium functional groups, among others. As used herein, an organosilane functional group is a functional group having at least one Si—C bond. Similarly, an organotitanium functional group is a functional group having at least one Ti—C bond, and an organozirconium functional group is a functional group having at least one Zr—C bond.

In some embodiments, the modified surface includes a surface polymer, which may comprise monomer residues that covalently or electrostatically bond to the hybrid organic-inorganic non-porous material. Examples of monomer residues that electrostatically bond to the hybrid organic-inorganic non-porous material include amide monomer residues and amine monomer residues. Examples of monomer residues that are covalently bonded to the hybrid organic-inorganic non-porous material include organosilane monomer residues, organotitanium monomer residues, and organozirconium monomer residues. As used herein, an organosilane monomer residue is a monomer residue having at least one Si—C bond, an organotitanium monomer residue is a monomer residue having at least one Ti—C bond, and an organozirconium monomer residue is a monomer residue having at least one Zr—C bond.

The surface polymer may comprise, for example, polymer chains that are grafted on the non-porous polymer core.

The surface polymer may comprise, for example, a crosslinked polymer network that is formed on the non-porous polymer particle core.

Surface polymers can be prepared via a number of processes and mechanisms including, but not limited to, chain addition and step condensation processes, radical, anionic, cationic, ring-opening, group transfer, metathesis, and photochemical mechanisms. In particularly beneficial embodiments, the non-porous polymer cores are prepared via free radical polymerization.

As noted above, polymer particle cores may contain surface moieties from which further polymerization can proceed. For example, organic polymer cores formed from free radical polymerization commonly contain residual radical-polymerizable unsaturated surface moieties (e.g., ethylenyl moieties, vinyl moieties, methacryloxy moieties, acryloxy moieties, etc.), from which polymerization of the surface polymer can proceed. Polymer chains can be from monofunctional monomers. Crosslinked polymer networks can be formed from multifunctional monomers. Monofunctional monomers may be included in addition to multifunctional monomers in such crosslinked polymer networks.

As noted above, surface polymers include those comprising amide monomer residues. Examples of amide monomer residues include amide monomer residues having the formula,

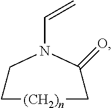

wherein n is an integer from 1-3 (i.e., N-vinyl pyrrolidone, N-vinyl-2-piperidinone or N-vinyl caprolactam). Examples of amide monomer residues also include amide monomer residues having the formula

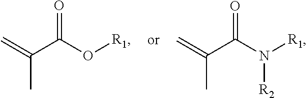

wherein R1 is selected from C1-C6 alkylene, C2-C6 alkenylene, C2-C6 alkynylene, C6-C18 arylene groups, and wherein R2 is selected from H, C1-C6 alkylene, C2-C6 alkenylene, C2-C6 alkynylene, C6-C18 arylene groups.

As also noted above, surface polymers include those comprising amine monomer residues. Examples of amine monomer residues include aminoalkyl acrylates, aminoalkyl methacrylates, dialkylaminoalkyl acrylates, or dialkylaminoalkyl methacrylates, including amino-C1-C4-alkyl acrylates, amino-C1-C4-alkyl methacrylates, di-C1-C4-alkylamino-C1-C4-alkyl acrylates, di-C1-C4-alkylamino-C1-C4-alkyl methacrylates, such as 2-aminoethyl acrylate, 2-aminoethyl methacrylate, 2-(N,N-dimethylamino)ethyl acrylate, 2-(N,N-dimethylamino)ethyl methacrylate, 2-(N,N-diethylamino)ethyl methacrylate, or 2-diisopropylaminoethyl methacrylate.

As further noted above, examples of surface polymers further include those comprising silane monomer residues that are electrostatically bonded to the hybrid organic-inorganic non-porous material. In some embodiments, the surface polymers comprise residues of one or more radical polymerizable organosilane monomers.

Specific examples of radical polymerizable organosilane monomers include unsaturated organosilane monomers (e.g., unsaturated organoalkoxysilane monomers, unsaturated organochlorosilane monomers, etc.), such as alkenyl- or alkynyl-functionalized organosilane monomers (e.g., alkenyl- or alkynyl-functionalized organoalkoxysilane monomers, alkenyl- or alkynyl-functionalized organochlorosilane monomers, etc.). Particular alkenyl-functionalized organoalkoxysilane monomers including those with vinyl groups, methacryloxy groups, and acryloxy groups. Specific examples include 3-(trimethoxysilyl)propyl methacrylate (also so known as 3-methacryloxypropyltrimethoxysilane, or MAPTMOS), methacryloxypropyltriethoxysilane, methacryloxypropyltrichlorosilane, vinyltriethoxysilane (VTES), vinyltrimethoxy silane, N-(3-acryloxy-2-hydroxypropyl)-3-aminopropyltriethoxysilane, (3-acryloxypropyl)trimethoxysilane, O-(methacryloxyethyl)-N-(triethoxysilylpropyl)urethane, N-(3-methacryl oxy-2-hydroxypropyl)-3-aminopropyltriethoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris(methoxyethoxy)silane, or 3-(N-styrylmethyl-2-aminoethylamino)propyltrimethoxysilane hydrochloride, among others.

In a particular embodiment of a process for forming a surface modified non-porous organic polymer core, an organosilane polymer, specifically, a poly(styryl-C1-C4-alkyl-tri-C1-C4-alkoxysilane), is formed by copolymerizing a styryl-C1-C4-alkyl-tri-C1-C4-alkoxysilane monomer where R is C1-C4 alkyl, with residual vinyl groups (e.g., residues of divinylbenzene) on a non-porous organic polymer core. Examples of styrene-based organosilane monomers include styrylethyltrimethoxysilane and styryltrimethoxysilane.

### Hybrid Organic-Inorganic Non-Porous Material.

As previously noted, the present disclosure pertains to non-porous composite particles in which a hybrid organic-inorganic non-porous material is disposed on a surface modified non-porous polymer core. The hybrid organic-inorganic non-porous material 130 forms and extends about an exterior of particle 100 as shown in FIG. 1 to create the layer. The modified surface 120 connects the material 130 to the core 110.

In some embodiments, the non-porous hybrid organic-inorganic material may have a thickness ranging for, for example, 1 nm to 4 microns, typically, from 25 nm to 200 nm. In some embodiments, the non-porous hybrid organic-inorganic material may have a pore volume, for example, less than 0.1 cc/g, (e.g., 0.05 cc/g), typically less than 0.02 cc/g.

An “organic-inorganic hybrid” material includes inorganic-based structures wherein an organic functionality is integral to both the internal or “skeletal” inorganic structure as well as the hybrid material surface. The inorganic portion of the hybrid material may be, e.g., silica, alumina, titanium, cerium, or zirconium or oxides thereof, or ceramic material. Exemplary hybrid materials are shown in U.S. Pat. Nos. 4,017,528, 6,528,167, 6,686,035, 7,175,913 and 7,919,177, the disclosures of which are hereby incorporated in their entirety.

In some embodiments, the hybrid organic-inorganic non-porous material may comprise a silicon-based hybrid organic-inorganic material that includes hybrid regions in which the silicon-based hybrid organic-inorganic material comprises silicon atoms having one or more silicon-oxygen bonds and one or more silicon-carbon bonds. In some cases, the hybrid regions may comprise a substituted or unsubstituted alkylene, alkenylene, alkynylene or arylene moiety bridging two or more silicon atoms. For example, the hybrid regions may comprise a substituted or unsubstituted C1-C18 alkylene, C2-C18 alkenylene, C2-C18 alkynylene or C6-C18 arylene moiety bridging two or more silicon atoms. In some embodiments, the hybrid regions may comprise a substituted or unsubstituted C1-C6 alkylene moiety bridging two or more silicon atoms, including methylene, dimethylene or trimethylene moieties bridging two silicon atoms. In some embodiments, the hybrid regions may comprise ≡Si—(CH2)n-Si≡ moieties, where n is an integer, and may be equal to 1, 2, 3, 4 or more. In some embodiments, the non-porous hybrid organic-inorganic layer may comprise a silicon-based hybrid organic-inorganic material that further comprises inorganic regions in which the material comprises silicon atoms having four silicon-oxygen bonds, in addition to hybrid regions in which the material comprises silicon atoms having one or more silicon-oxygen bonds and one or more silicon-carbon bonds.

In various embodiments, hybrid organic-inorganic materials may be formed by hydrolytically condensing one or more organosilane compounds on surface modified non-porous organic polymer cores, such as those described above. As used herein, an organosilane compound is a silane compound having at least one Si—C bond.

The organosilane compounds may comprise, for example, (a) one or more organosilane compounds of the formula SiZ1Z2Z3Z4, where Z1, Z2, Z3 and Z4 are independently selected from Cl, Br, I, C1-C4 alkoxy, C1-C4 alkylamino, and C1-C4 alkyl, where at least one of Z1, Z2, Z3 and Z4 is C1-C4 alkyl, examples of which include alkyl-trialkoxysilanes such as C1-C4-alkyl-tri-C1-C4-alkoxysilanes, including methyl triethoxysilane, methyl trimethoxysilane, ethyl trimethoxysilane or ethyl triethoxysilane, and dialkyl-dialkoxysilanes, for example, C1-C4-dialkyl-di-C1-C4-alkoxysilanes, such as dimethyl diethoxysilane, dimethyl dimethoxysilane, diethyl dimethoxysilane or diethyl diethoxysilane, among many other possibilities and/or (b) one or more organosilane compounds of the formula Z1Z2Z3Si—R—SiZ4Z5Z6, where Z1, Z2 and Z3 are independently selected from Cl, Br, I, C1-C4 alkoxy, C1-C4 alkylamino, and C1-C4 alkyl, although at most two of Z1, Z2 and Z3 can be C1-C4 alkyl, where Z4, Z5 and Z6 are independently selected from Cl, Br, I, C1-C4 alkoxy, C1-C4 alkylamino, and C1-C4 alkyl, although at most two of Z4, Z5 and Z6 can be C1-C4 alkyl, and where R is an organic radical, for example, selected from C1-C18 alkylene, C2-C18 alkenylene, C2-C18 alkynylene or C6-C18 arylene groups, typically, C1-C4 alkylene, typically, C1-C6 alkylene. Examples of compounds of the formula Z1Z2Z3Si R SiZ4Z5Z6 include bis(trialkoxysilyl)alkanes, for instance, bis(tri-C1-C4-alkoxysilyl)C1-C4-alkanes such as bis(trimethoxysilyl)methane, bis(trimethoxysilyl)ethane, bis(triethoxysilyl)methane, and bis(triethoxysilyl)ethane, among many other possibilities.

In some embodiments, one or more additional non-organosilane compounds may be hydrolytically condensed along with the one or more organosilane compounds. Such compounds include silane compounds of the formula SiZ1Z2Z3Z4, where Z1, Z2, Z3 and Z4 are independently selected from Cl, Br, I, C1-C4 alkoxy and C1-C4 alkylamino. In certain embodiments the additional silane compounds are tetra-C1-C4-alkoxysilanes such as tetramethoxysilane or tetraethoxysilane.

In some embodiments, hybrid organic-inorganic materials may be formed by hydrolytically condensing the following on a surface modified non-porous organic polymer core as described above: (a) one or more alkyoxysilanes, for example, tetraalkoxysilanes (e.g., tetramethoxysilane (TMOS), tetraethoxysilane (TEOS), etc.) and (b) one or more organosilanes, for example, selected from bis(trialkoxysilyl)alkanes (e.g., bis(trimethoxysilyl)methane, bis(trimethoxysilyl)ethane, bis(triethoxysilyl)methane, bis(triethoxysilyl)ethane (BTEE), etc.) and/or alkyltrialkoxysilanes (e.g., methyl trimethoxysilane, methyl triethoxysilane (MTOS), ethyl triethoxysilane, etc.). Where the plurality of silane compounds comprises one or more bis(trialkoxysilyl)alkanes, alkyl-bridged hybrid organic-inorganic materials are prepared, which can offer various advantages over conventional silica-based materials, including chemical and mechanical stability. When BTEE is employed as a monomer, the resulting materials are ethylene bridged hybrid (BEH) materials. One particular BEH material can be formed from hydrolytic condensation of TEOS and BTEE.

In some embodiments, a plurality of silane compounds as described above, for example, a plurality of silane compounds comprising one or more organosilanes and one or more tetraalkoysilanes are partially condensed to form a polyalkoxyorganosiloxane oligomer, which is then hydrolytically condensed onto a surface modified non-porous organic polymer core. For example, BTEE and TEOS can be partially condensed to form a polyethoxyorganosiloxane oligomer (PEOS), which is hydrolytically condensed onto a surface modified non-porous organic polymer core.

In various embodiments, a hybrid organic-inorganic non-porous material may be formed by creating (typically in a series of steps) a reaction mixture comprising the following components: surface modified non-porous organic polymer cores, ethanol, one or more silanes including one or more organosilanes as previously described (e.g., TEOS and BTEE, or PEOS), water, and a basic or acidic catalyst to promote silane hydrolysis and condensation of hybrid organic-inorganic material on the surface modified non-porous organic polymer cores. In some embodiments, the hydrolysis proceeds at room temperature. In some embodiments, the mixture may be heated to drive the hydrolysis reaction to completion. In some embodiments, the mixture is agitated. After forming the hybrid organic-inorganic non-porous material, the resulting particles may be washed and dried.

In other embodiments, a hybrid organic-inorganic non-porous material may be formed by interaction between a template surfactant (e.g., and ionic surfactant such as cetyltrimethyl ammonium bromide (CTAB) or trioctylmethylammonium bromide (TOMB)) and one or more silanes including one or more organosilanes as previously described (e.g., TEOS and BTEE, or PEOS) during continuous addition of silanes, basic catalyst and template surfactant to surface modified non-porous organic polymer cores. This process leads to continuous silane hydrolysis and condensation of hybrid organic-inorganic reaction product on the cores. The reaction may be conducted at room temperature or at elevated temperatures.

One or more organosilanes as previously described (e.g., TEOS and BTEE, or PEOS) may be hydrolyzed in the presence of a surface modified non-porous (NP) organic polymer core having a surface polymer that comprises monomer residues of amide monomers and/or silane monomers such that the hydrolyzed organosilanes form a hybrid organic-inorganic non-porous layer or region on the core.

Potential advantages of the non-porous composite particles of the present disclosure include improvements in mass transfer and increased efficiencies relative to non-porous silica particles, along with improved pH stability. The non-porous composite particles can be used as chromatography packing materials for the separation of both small molecules and large biologics.

### Chromatographic Devices.

In some aspects of the present disclosure, the non-porous composite particles described herein may be provided in a suitable chromatographic device. For this purpose, the non-porous composite particles described herein may be provided in conjunction with a suitable housing. The non-porous composite particles and the housing may be supplied independently, or the non-porous composite particles may be pre-packaged in the housing. Housings for use in accordance with the present disclosure commonly include a chamber for accepting and holding non-porous composite particles. In various embodiments, the housings may be provided with an inlet and an outlet leading to and from the chamber.

Suitable construction materials for the chromatographic housings include inorganic materials, for instance, metals such as stainless steel and ceramics such as glass, as well as synthetic polymeric materials such as polyethylene, polypropylene, polyether ether ketone (PEEK), and polytetrafluoroethylene, among others.

In certain embodiments, the chromatographic housings may include one or more filters which act to hold the non-porous composite particles in a housing. Exemplary filters may be, for example, in a form of a membrane, screen, frit or spherical porous filter.

In certain embodiments, the chromatographic device is a chromatographic column.

The present disclosure also provides for a kit comprising the non-porous composite particles, housings or devices as described herein and instructions for use. In one embodiment, the instructions are for use with a separation device, e.g., a chromatographic column.

### Chromatographic Separations.

In some aspects of the present disclosure, the non-porous composite particles of the present disclosure can be used in a variety of chromatographic separation methods. As such, the chromatographic devices and chromatographic kits described herein can also be utilized for such methods. Examples of chromatographic separation methods in which the non-porous composite particles of the invention can be used include used in both high-pressure liquid chromatography (HPLC) and ultra-high pressure liquid chromatography (UHPLC) in different modes. Those modes include, but are not limited to, affinity separation, hydrophilic interaction chromatography (HILIC) separations, normal-phase separations, reversed-phase separations, chiral separations, supercritical fluid chromatography SFC separations, perfusive separations, size-exclusion chromatography (SEC) separations, ion exchange separations, or multimode separations.

The non-porous composite particles, devices and kits of the present disclosure may be used for chromatographic separations of small molecules, carbohydrates, antibodies, whole proteins, peptides, and/or DNA, among other species.

Such chromatographic separations may comprise loading a sample onto non-porous composite particles in accordance with the present disclosure and eluting adsorbed species from the non-porous composite particles with a mobile phase.

Such chromatographic separations may be performed in conjunction with a variety of aqueous and/or organic mobile phases (i.e., in mobile phases that contain water, an organic solvent, or a combination of water and organic solvent) and in conjunction with a variety of mobile phase gradients, including solvent species gradients, temperature gradients, pH gradients, salt concentration gradients, or gradients of other parameters.

The following examples are provided to illustrate how to make composite particles and their components in accordance with the present technology. The examples are provided for illustrative purposes only and should not be considered to be limiting. When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the present technology be limited to the specific values recited when defining a range.

### Example 1. Non-Porous Poly(DVB80) Particulate Core

In this example, an exemplary non-porous core is manufactured. Other processes and other materials can be utilized for making the non-porous polymer core of the composite particles of the present technology.

The inhibitor in divinylbenzene (80%, technical grade) used in the particle synthesis was removed by passing the monomer through an alumina cartridge.

Primary particle synthesis: In this particle synthesis experiment (sample 1A in Table 1 below), 65.1 grams of PVP-40, 8.9 grams of Triton N-57, 2452.6 grams of reagent alcohol (905 ethanol, 5% methanol and 5% isopropanol) and 153.3 grams g of p-xylene were charged into a 4 L cylinder flask reactor equipped with mechanical agitation, condenser and thermocouple. The mixture was mixed with agitation at 200 RPM and the dissolved oxygen in the solution was removed by sub-surface purging with nitrogen. After dissolved oxygen is below 1 ppm, 2.1 grams of azobisisobutyronitrile and 105 grams of divinylbenzene was charged into the reaction. The reaction temperature was raised to 70° C. and held at this temperature for 20 hrs. Primary core growth: When 20 hours of reaction time was reached, the temperature was maintained at 70° C. and 1.8 grams of azobisisobutyronitrile was added. Subsequently, a solution of 67.6 grams of divinylbenzene and 20.3 grams of PVP-40 in 202.7 grams of reagent alcohol was metered in via a pump at a constant flow rate over 120 minutes. The reaction was continued at 70° C. for at least 12 hours. After reaction, the particles were separated from the reaction slurry by filtration, followed by washing sequentially with methanol, tetrahydrofuran (THF) and acetone. The final product was dried in vacuum oven at 45° C. overnight. Approximately 147 grams of 1.95 μm particles were obtained.

To test the effect of adjusting the amount of PVP-40 in the beginning of the reaction, three different amounts (65.1 g—sample 1A; 48.9 g—sample 1B; and 109.2 g—sample 1C) were evaluated. Table 1 below provides the results, which indicate that particle size is inversely related to the amount of PVP-40.

TABLE 1

| | PVP-40, | Particle size, | Specific surface area, | Pore volume, |
|---|---|---|---|---|
| Sample | g | μm | m²/g | cc/g |
| 1A | 65.1 | 1.95 | 36.0 | 0.04 |
| 1B | 48.9 | 2.22 | 30.8 | 0.03 |
| 1C | 109.2 | 1.27 | 38.5 | 0.04 |

### Example 2. Non-Porous Poly(DVB80-Co-Styrene) Particulate Core

In this example, an exemplary non-porous core is manufactured which includes a polymer core including two different polymers. Other processes and other materials can be utilized for making the non-porous polymer core of the composite particles of the present technology.

The inhibitor in both divinylbenzene (80%, technical grade) and styrene used in the particle synthesis was removed by passing the monomers through an alumina cartridge.

Primary particle synthesis: In this particle synthesis experiment (sample 2A) 78.2 grams of PVP-40, 8.9 grams of Triton N-57, 2452.6 grams of reagent alcohol (905 ethanol, 5% methanol and 5% isopropanol) and 153.3 grams g of p-xylene were charged into a 4 L cylinder flask reactor equipped with mechanical agitation, condenser and thermocouple. The mixture was mixed with agitation at 200 RPM and the dissolved oxygen in the solution was removed by sub-surface purging with nitrogen. After dissolved oxygen is below 1 ppm, 2.1 grams of azobisisobutyronitrile, 42 grams of divinylbenzene (80%, technical grade) and 63.0 grams of styrene were charged into the reaction. The reaction temperature was raised to 70° C. and held at this temperature for 20 hrs.

Primary core growth: When 20 hours of reaction time was reached, the temperature was maintained at 70° C. and 1.8 grams of azobisisobutyronitrile was added. Subsequently, a solution of 67.6 grams of divinylbenzene and 19.2 grams of PVP-40 in 192.0 grams of reagent alcohol was metered in via a pump at a constant flow rate over 120 minutes. The reaction was continued at 70° C. for at least 12 hours. After reaction, the particles were separated from the reaction slurry by filtration, followed by washing sequentially with methanol, tetrahydrofuran (THF) and acetone. The final product was dried in vacuum oven at 45° C. overnight. Approximately 135 grams of 2.2 μm particles were obtained.

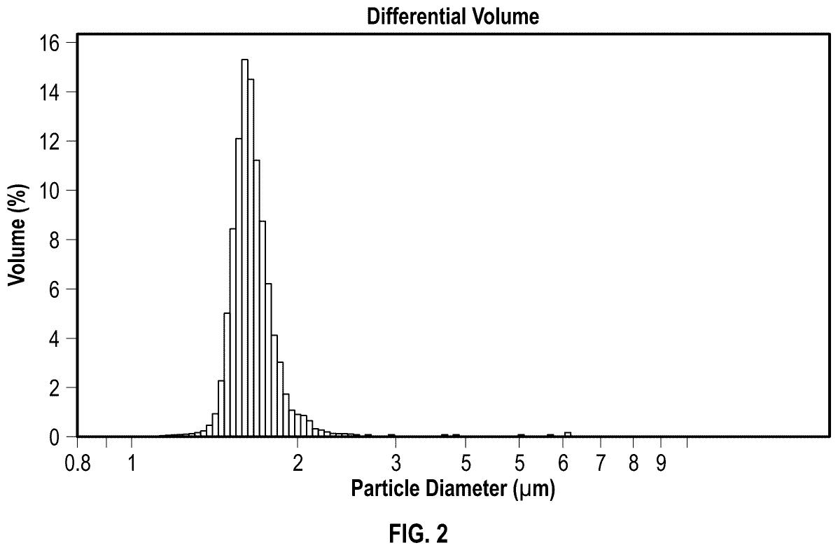

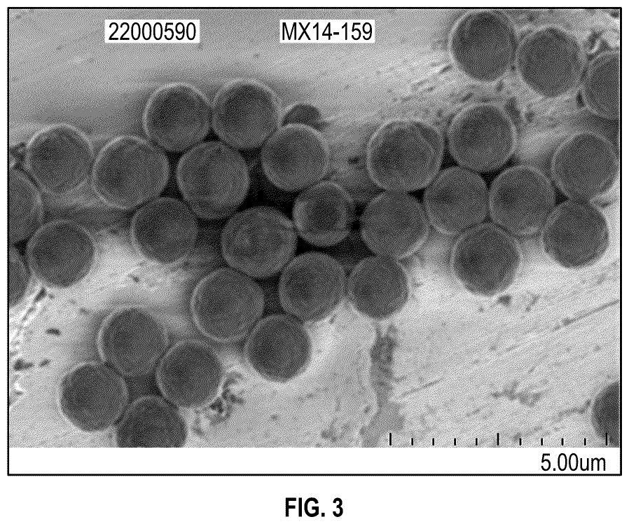

Below, in Table 2, samples 2A to 2C describe the synthesis of poly(DVB80-co-styrene) particles with different DVB80 and styrene compositions by adjusting the amount of DVB80 and styrene charged in the primary core synthesis step of the core growth step. The particle size distribution of poly(DVB80-co-styrene) of sample 2C is described in the graph of FIG. 2 and an micrograph image of the particles is depicted in FIG. 3.

TABLE 2

| | Primary core | | | | | | Pore |
|---|---|---|---|---|---|---|---|
| | synthesis | | Primary core growth | | Particle | Specific surface | volume |
| Sample | DVB80, g | Styrene, g | DVB80, g | Styrene, g | size, μm | area m²/g | cc/g |
| 2A | 42.0 | 63.0 | 67.6 | 0.0 | 2.07 | 8.2 | 0.010 |
| 2B | 63.0 | 42.0 | 38.4 | 25.6 | 1.72 | 2.1 | 0.005 |
| 2C | 105.0 | 0.0 | 30.5 | 20.3 | 1.63 | 6.3 | 0.008 |
| 2D | 57.8 | 47.2 | 63.7 | 0.0 | 2.32 | 18.4 | 0.02 |

### Example 3. Larger Particulate Core Made from Another Smaller Core

In this example, an exemplary non-porous core, which includes a core made in two stages is manufactured. Other processes and other materials can be utilized for making the non-porous polymer core of the composite particles of the present technology.

120 grams of particle (particle size, 2.32 μm) made by the method described in sample 2D, were re-dispersed in a solution containing 37.0 grams of PVP-40, 4.5 grams g of Triton™ N-57, 100.0 grams of p-xylene and 1234.0 grams of reagent alcohol (90% ethanol, ˜5% methanol and ˜5% isopropanol), then charged into a 4 liter kettle reactor equipped with mechanical agitation, condenser reactor and thermocouple. The slurry was mixed at 200 RPM and purged with nitrogen via subsurface to obtain a dissolved oxygen below 1 ppm. Once the dissolved oxygen in the solution is less than 1 ppm, the nitrogen subsurface sparging was changed to blanket sparging, the agitation speed was adjusted to 75 RPM and then the reaction temperature was raised to 70° C. When the reaction temperature reached 70° C., 4.8 grams of divinylbenzene (80%, inhibitor was removed with aluminum oxide) and 3.0 grams of AIBN were added. 15 minutes later, a solution containing 139.5 grams of divinylbenzene (80%, inhibitor was removed with aluminum oxide), 105.6 grams of PVP-40 and 1345.7 grams of reagent alcohol was added via a pump at a constant rate over 2 hours. After addition, the reaction was held for 20 hours at 70° C. After reaction, the particles were separated from the reaction slurry by filtration. The particles were washed with methanol, followed with tetrahydrofuran (THF), and lastly with acetone. The final product was dried in vacuum oven at 45° C. overnight. 250 grams of monodisperse 3.0 μm particles were obtained.

### Example 4. Core Surface Prime with Silane Functionality

In this example, an exemplary primed, non-porous core is manufactured. Other processes and other materials can be utilized for making the primed, non-porous polymer core of the composite particles of the present technology.

The inhibitor in both divinylbenzene (80%, technical grade) and styryl ethyltrimethoxysilane was removed by passing through an alumina cartridge. The reagent alcohol used in the reaction contained 90% ethanol, ˜5% methanol and ˜5% isopropanol. In this particle synthesis experiment (see sample 4A in Table 3 below), 44.7 grams of PVP-40, 165.2 grams g of p-xylene were charged into a 4 L round bottom flask reactor equipped with mechanical agitation, condenser reactor and thermocouple. A slurry of 145.0 grams of particles (sample 1A, from example 1) in 1490.7 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 2.9 grams of divinylbenzene and 2.5 grams of 2,2′-Azobis(2-methylpropionitrile) (AIBN) were added. After 15 minutes of mixing, a solution containing 14.5 grams of styryl ethyltrimethoxysilane, 1.5 grams of divinylbenzene and 13.9 grams of PVP-40 in 464.0 grams of reagent alcohol was added at a constant flow rate over 2 hours. After the reaction was held at 70° C. for a total of 20 hrs, the reaction was cooled to below 40° C. and the produced particles were separated from the reaction slurry by filtration. The particles were washed with methanol, followed with tetrahydrofuran (THF), and lastly with acetone. The final product was dried in vacuum oven at 45° C. overnight. 149.0 grams of primed particles were obtained.

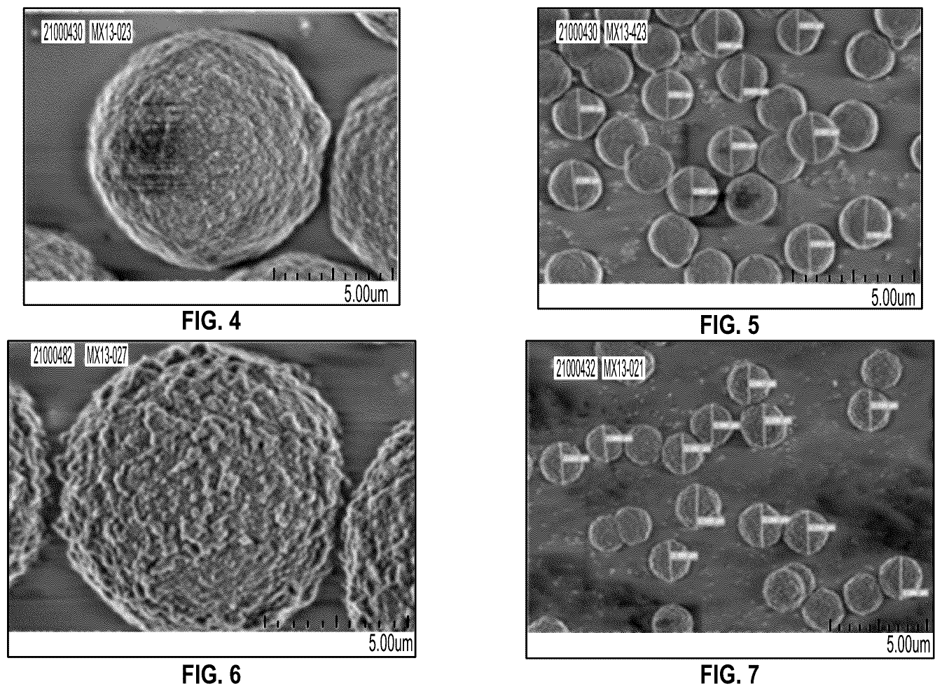

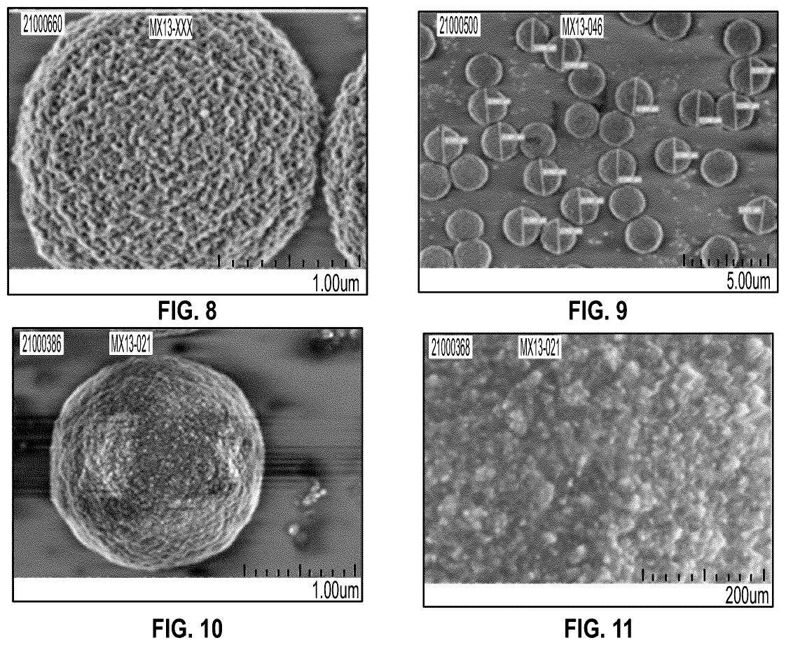

Table 3 provides the synthesis of primed particles with different surface morphology and primer layer thickness by adjusting the amount of primer monomer use and the amount of crosslinker DVB80 used in numerous different samples. FIGS. 4-9 show primed particles, in accordance with samples below, with different surface morphology and primer layer thickness. FIGS. 4 and 5 depict the primed particles of the sample 4G. FIGS. 6 and 7 depict the primed particles of the sample 4H. FIGS. 8 and 9 depict the primed particles of the sample 41.

TABLE 3

| | Surface | Pore | Core slurry, g | | | | | | Primer solution, g | | | |
|---|---|---|---|---|---|---|---|---|---|---|---|---|
| | area | volume | Core | Reagent | p- | PVP- | | | | Styryl | PVP- | Reagent |
| Sample | m²/g | cc/g | particle | alcohol | Xylene | 40 | AIBN | DVB80 | DVB80 | ethyltrimethoxylsilane | 40 | alcohol |
| 4A | 4.8 | 0.015 | 145.0 | 1490.7 | 165.2 | 44.7 | 2.5 | 2.9 | 1.5 | 14.5 | 13.9 | 464.0 |
| 4B | 4.3 | 0.013 | 135.0 | 1387.9 | 153.8 | 41.6 | 2.4 | 2.7 | 1.4 | 13.5 | 13.0 | 432.0 |
| 4C | 1.6 | 0.005 | 145.0 | 1490.7 | 165.2 | 44.7 | 2.5 | 2.9 | 1.5 | 14.5 | 13.9 | 464.0 |
| 4D | 4.6 | 0.014 | 125.0 | 1285.0 | 142.4 | 38.6 | 2.2 | 2.3 | 1.2 | 11.6 | 4.2 | 140.9 |
| 4E | 4.6 | 0.014 | 138.0 | 1387.9 | 153.8 | 41.6 | 2.4 | 2.7 | 1.4 | 13.5 | 13.0 | 432.0 |
| 4F | 6.1 | 0.019 | 130.0 | 1336.4 | 148.1 | 40.1 | 2.3 | 2.6 | 1.3 | 13.0 | 12.5 | 416.0 |
| 4G | 4.2 | 0.014 | 50.0 | 514.0 | 57.0 | 15.4 | 0.9 | 0.9 | 0.5 | 4.7 | 1.7 | 56.4 |
| 4H | 5.1 | 0.015 | 50.0 | 514.0 | 57.0 | 15.4 | 0.9 | 1.8 | 0.9 | 9.0 | 3.6 | 120.0 |
| 4I | 11.6 | 0.039 | 50.0 | 528.8 | 58.6 | 15.9 | 0.9 | 2.5 | 1.3 | 12.7 | 3.0 | 101.3 |

### Example 5. Core Surface Prime with Other Functionality

In this example, an exemplary primed, non-porous core is manufactured having various functionality. Other processes and other materials can be utilized for making the primed, non-porous polymer core of the composite particles of the present technology.

Here, referring to sample 5A (shown below), the primer monomer of the primed, non-porous polymer core was replaced. Specifically, the reagent alcohol used in the reaction contains 90% ethanol, ˜5% methanol and ˜5% isopropanol. In this particle synthesis experiment, 15.4 grams of PVP-40 and 57.0 grams of p-xylene were charged into a 1 L round bottom flask reactor equipped with mechanical agitation, a condenser, a reactor, and a thermocouple. A slurry of 50.0 grams of particle made in example 3 in 514.0 grams of reagent alcohol was added. The mixture was mixed at 200 RPM for 24 hours. Then the reaction slurry was purged with nitrogen via sub-surface to obtain a dissolved oxygen below 1 ppm. Once the dissolved oxygen in the solution is less than 1 ppm, the reaction mixture was heated to 70° C. and the agitation speed was adjusted to 75 RPM. Then, 1.8 grams of divinylbenzene and 0.9 grams of 2,2′-Azobis(2-methylpropionitrile) (AIBN) were added. After 15 minutes of mixing, a solution containing 9.0 grams of N-vinyl pyrrolidone, 0.9 grams of divinylbenzene and 3.6 grams of PVP-40 in 120.0 grams of reagent alcohol was added at a constant flow rate over 2 hours. After the reaction was held at 70° C. for a total of 20 hrs, the reaction was cooled to below 40° C. and the produced particles were separated from the reaction slurry by filtration. The particles were washed with methanol, followed with tetrahydrofuran (THF), and lastly with acetone. The final product was dried in vacuum oven at 45° C. overnight. 54.0 grams of primed particles were obtained.

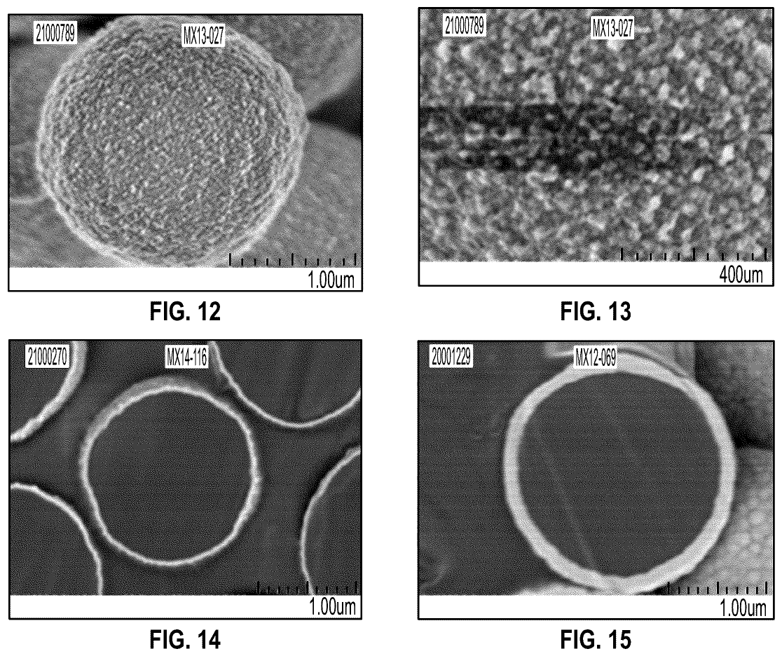

Samples 5A to 5E, shown below, describe the synthesis of primed particles with different surface functionalities. In each sample, the primer monomer was replaced in the formulation of the primed, non-porous polymer core. While the experiment described above utilizes sample 5A, other experiments were performed utilizing samples 5B to 5E. FIGS. 10 and 11 depict a particle prior to priming, and FIGS. 12 and 13 depict the morphology change of the particle of FIGS. 5 and 6 after the particle is primed with poly(N-vinyl pyrrolidone).

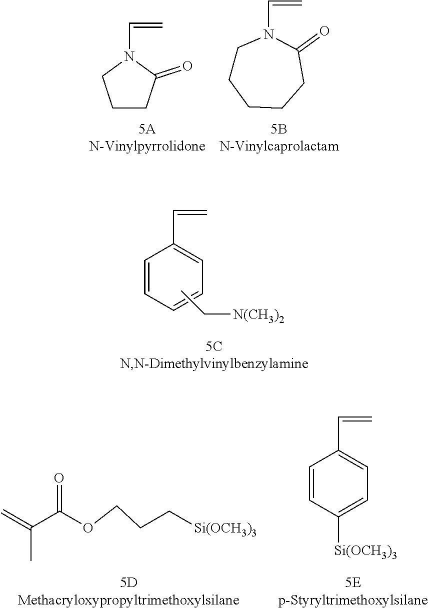

### Example 6. Non-Porous Hybrid Coating on Trimethoxylsilane Primed Core

In this example, an exemplary primed, non-porous core with a hybrid coating is manufactured to form a non-porous composite particle in accordance with the present technology. Other processes and other materials can be utilized for making the primed, non-porous polymer core with a hybrid coating of the composite particles of the present technology.

In this particle synthesis experiment (i.e., to for sample 6A), a 5 L round bottom flask reactor equipped with mechanical agitation, a condenser, reactor, and thermocouple, was set up in a sonication bath capable of heating (490 watts). 140.0 grams of silane primed core (sample 4A) was re-dispersed in 1120.0 grams of 200 proof ethanol and then charged into reactor. 1120.0 grams of toluene and 26.9 grams of Pluronic F127 and 77.1 grams of ammonium hydroxide (28-30% aqueous solution) were added to the slurry of the reactor. The temperature of the sonication bath was raised to 35° C. and start sonication. The sonication was maintained through the entire coating process. When the sonication bath temperature reached 35° C., a solution containing 98.2 grams of tetraethyl orthosilicate (TEOS), 41.8 grams of 1,2-bis(triethoxysilyl), ethane (BTEE), 3.5 grams of Pluronic F127 in a mixed solvent of 70.0 grams of ethanol (200 proof), and 70.0 grams of toluene, was metered into the reactor at a constant flow rate over 6 hours. After the addition, the reaction was held at 35° C. for 24 hours. The coated were isolated by filtration and washed with methanol for 6 times. The final product was dried in vacuum oven at 70° C. overnight. 174.0 grams of non-porous BEH coated particles (i.e., sample 4A particles coated with non-porous BEH material) were obtained.

Table 4 below provides the synthesis of non-porous hybrid coated particle with different coating thickness and surface morphology by adjusting the amount of TEOS, BTEE and the use or not use of surfactant (samples 6A-6H). FIG. 14 and FIG. 15 depict the non-porous hybrid coated particle of samples 6D and 6H, respectively, showing hybrid coated particles with different coating thickness and surface morphology.

TABLE 4

| | Surface | Pore | Particle | Coating | | | | | |
|---|---|---|---|---|---|---|---|---|---|
| | area | volume | szie | thickness | Primed core particle | | | Coating monomer | |
| Example 6 | m²/g | cc/g | μm | nm | ID | Charge, g | Surfactant | TEOS, g | BTEE, g |
| 6A | 4.8 | 0.011 | 2.05 | 48.5 | example 4A | 140 | Pluronic F127 | 98.2 | 41.8 |
| 6B | | | | 190.0 | example 4F | 130 | No surfactant | 284.2 | 120.8 |
| 6C | | | | 67.0 | example 4E | 130 | No surfactant | 134.5 | 57.2 |
| 6D | 4.2 | 0.011 | 2.23 | 50.0 | example 4D | 40 | Pluronic F127 | 28.1 | 11.9 |
| 6E | 4.4 | 0.010 | 2.25 | 51.0 | example 4B | 90 | Pluronic F127 | 63.2 | 26.9 |
| 6F | 5.3 | 0.012 | 1.91 | 31.0 | example 4C | 90 | Pluronic F127 | 63.2 | 26.9 |
| 6G | 4.1 | 0.029 | | 175.0 | | 3 | PE-block-PEO, | 8.0 | 2.0 |
| | | | | | | | Mw = 1400 | | |
| 6H | 5.7 | 0.007 | | 178.0 | | 3 | Triton X-100 | 8.0 | 2.0 |

### Example 7. Non-Porous Hybrid Coating on Pyrrolidone Primed Core

In this example, an exemplary primed (primed with pyrrolidone), non-porous core with a hybrid coating is manufactured. Other processes and other materials can be utilized for making the primed, non-porous polymer core with a hybrid coating of the composite particles of the present technology.

A 5 L round bottom flask reactor equipped with mechanical agitation, a condenser, reactor, and thermocouple were set up in a sonication bath capable of heating (490 watts). 14.0 grams of pyrrolidone primed core (sample 5A) was re-dispersed in 112.0 grams of 200 proof ethanol and then charged into reactor. 112.0 grams of toluene, 2.7 grams of Pluronic F127 and 7.7 grams of ammonium hydroxide (28-30% aqueous solution) were added to the slurry of the reactor. The sonication bath temperature was raised to 35° C. for sonication. The sonication was maintained through the entire coating process. When the sonication bath temperature reached 35° C., a solution containing 9.8 grams of tetraethyl orthosilicate (TEOS), 4.2 grams of 1,2-bis(triethoxysilyl) ethane (BTEE), 0.4 grams of Pluronic F127 in a mixed solvent of 7.0 grams of ethanol (200 proof), and 7.0 grams of toluene was metered into the reactor at a constant flow rate over 6 hours. After the addition, the reaction was held at 35° C. for 24 hours. The coated particles were isolated by filtration and washed with methanol for 6 times. The final product was dried in vacuum oven at 70° C. overnight. 16.0 grams of non-porous BEH coated particles were obtained.

### Example 8. Non-Porous Hybrid Coating with High Organic Composition

In this example, a non-porous hybrid coating having a high organic content is manufactured and forms a layer of material about a primed non-porous polymer core. Other processes and other materials can be utilized for making the non-porous coating of the composite particles of the present technology.

Equipped with a mechanical agitation, a condenser and a thermocouple, a 3 L round bottom flask reactor was placed in a sonication bath capable of heating (490 watts). 75.0 grams of silane primed core material (sample 4D, example 4) was re-dispersed in 75.0 grams of 200 proof ethanol and then charged into the reactor. 750.0 grams of toluene and 79.7 grams of ammonium hydroxide (28-30% aqueous solution) were added to the slurry of the reactor. The sonication bath temperature was raised to 35° C. and sonication was started. The sonication was maintained through the entire coating process. When the sonication bath temperature reached 35° C., a solution containing 42.3 grams of tetraethyl orthosilicate (TEOS), 107 grams of 1,2-bis(triethoxysilyl) ethane (BTEE) in a mixed solvent of 241.7 grams of ethanol (200 proof), and 241.7 grams of toluene was metered into the reactor at a constant flow rate over 6 hours. After the addition, the reaction was held at 35° C. for 24 hours. The coated particles were isolated by filtration and washed with methanol 6 times. The final product was dried in vacuum oven at 70° C. overnight. 110.0 grams of coated particles were obtained.

### Example 9. Non-Porous Hybrid Coating with a Mixture of Methylene and Ethylene Bridged Organic Silanes

In this example, another non-porous hybrid coating is manufactured and forms a layer of material about a primed non-porous polymer core. Other processes and other materials can be utilized for making the non-porous coating of the composite particles of the present technology.

Equipped with a mechanical agitator, a condenser, and a thermocouple, a 1 L round bottom flask reactor was placed in a sonication bath capable of heating (490 watts). 18.0 grams of silane primed core was re-dispersed in 144.0 grams of 200 proof ethanol and then charged into reactor. 144.0 grams of toluene and 10.5 grams of ammonium hydroxide (28-30% aqueous solution) were added to the slurry of the reactor. The sonication bath temperature was raised to 35° C. and sonication was started. The sonication was maintained through the entire coating process. When the sonication bath temperature reached 35° C., a solution containing 71.4 grams of bis(triethoxysilyl)methane, 18.6 grams of 1,2-bis(triethoxysilyl) ethane (BTEE) in a mixed solvent of 90.0 grams of ethanol (200 proof), and 90.0 grams of toluene were metered into the reactor at a constant flow rate over 6 hours. After the addition, the reaction was held at 35° C. for 24 hours. The coated particles were isolated by filtration and washed with methanol 6 times. The final product was dried in a vacuum oven at 70° C. overnight.

### Example 10. Non-Porous Hybrid Coating with Gradient Inorganic/Organic Ratio

In this example, a non-porous hybrid coating having a change in the inorganic/organic ratio through at least a portion of its thickness is manufactured and forms a layer about a primed non-porous polymer core. Other processes and other materials can be utilized for making the non-porous coating of the composite particles of the present technology.

Equipped with a mechanical agitation, a condenser, and a thermocouple, a 1 L round bottom flask reactor was placed in a sonication bath capable of heating (490 watts). 18.0 grams of silane primed core material (sample 4F, example 4) was re-dispersed in 144.0 grams of 200 proof ethanol and then charged into reactor. 144.0 grams of toluene and 10.5 grams of ammonium hydroxide (28-30% aqueous solution) were added to the slurry of the reactor. The sonication bath temperature was raised to 35° C. and sonication was started. The sonication was maintained through the entire coating process. When the sonication bath temperature reached 35° C., a solution containing 27.5 grams of tetraethyl orthosilicate (TEOS) and 7.5 grams of 1,2-bis(triethoxysilyl) ethane (BTEE) in a mixed solvent of 45.0 grams of ethanol (200 proof) and 45.0 grams of toluene was metered into the reactor at a constant flow rate over 4 hours. After two hours, solution A, solution B containing 40 grams of 1,2-bis(triethoxysilyl) ethane (BTEE) in a mixed solvent of 45.0 grams of ethanol (200 proof), and 45.0 grams of toluene was metered into the reactor at a constant flow rate over 4 hours. After the completion of both solution A and solution B, the reaction was held at 35° C. for 24 hours. The coated particles were isolated by filtration and washed with methanol 6 times. The final product was dried in vacuum oven at 70° C. overnight.

1. A non-porous composite particle comprising:
a non-porous polymer particle core having a silyl modified surface; and
a non-porous hybrid organic-inorganic layer in contact with the silyl modified surface.

2. The particle of claim 1, wherein the non-porous polymer particle core is a product of at least one monomer.

3. The particle of claim 2, wherein the at least one monomer is a radical polymerizable monomer.

4. The particle of claim 2, wherein the at least one monomer comprises at least two functional groups.

5. The particle of claim 2, wherein the at least one monomer is capable of polymerizing by ring opening polymerization or condensation polymerization.

6. The particle of claim 1, wherein the non-porous polymer particle core comprises divinylbenzene (80%).

7. The particle of claim 1, wherein the silyl modified surface of the non-porous polymer particle core comprises a first functionality and a second functionality, the first functionality comprising a reactive silane and the second functionality comprising an organic polymerizable group.

8. The particle of claim 7, wherein the reactive silane comprises an alkoxy.

9. The particle of claim 7, wherein the organic polymerizable group comprises vinyl.

10. The particle of claim 1, wherein the silyl modified surface of the non-porous polymer particle being modified with at least one of N-Vinylpyrrolidone, N-Vinylcaprolactam, N,N-Dimethylvinylbenzylamine, Methacryloxypropyltrimethoxylsilane, or p-Styryltrimethoxysilane.

11. The particle of claim 1, wherein the silyl modified surface of the non-porous polymer particle core comprises at least one functional group that covalently bonds with an organometallic compound.

12. The particle of claim 1, wherein the silyl modified surface of the non-porous polymer particle core comprises at least one functional group that electrostatically interacts with the non-porous hybrid organic-inorganic layer.

13. The particle of claim 1, wherein the non-porous hybrid organic-inorganic layer has a thickness range of 1 nm to 4 microns, more preferably from 25 nm to 200 nm.

14. The particle of claim 1, wherein the non-porous hybrid organic-inorganic layer has a pore volume less than 0.10 cc/g.

15. The particle of claim 1, wherein the non-porous hybrid organic-inorganic layer comprises a material selected from the group consisting of: silica, alumina, titanium, cerium, zirconium, silica oxide, alumina oxide, cerium oxide, zirconium oxide, ceramic material, and combinations thereof.

16. The particle of claim 1, wherein the non-porous hybrid organic-inorganic layer comprises a silicon-based material.

17. The particle of claim 16, wherein the silicon-based material comprises silicon atoms having one or more silicon-oxygen bonds and one or more silicon-carbon bonds.

18. The particle of claim 16, wherein the non-porous hybrid organic-inorganic layer comprises a substituted or unsubstituted alkylene, alkenylene, alkynylene or arylene moiety bridging two or more silicon atoms.
